(19) United States
(12) Patent Application Publication
(10) Pub. No.: US 2006/0256357 A1
(43) Pub. Date: Nov. 16, 2006

(54) System and method for improved printing efficiency

(75) Inventors: Darin Hochwender, Omaha, NE (US); William Bartelt, Carter Lake, IA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/127,033

(22) Filed: May 10, 2005

(51) Int. Cl. G06F 3/12; G06F 15/00

(52) U.S. Cl. 358/1.13; 358/1.16

(57) ABSTRACT

In accordance with the present invention, the efficiency of printing systems are improved by manipulating the print data stream (PDS), e.g., an AFP data stream (AFPDS) prior to communication to the printer. The methods generally involve manipulating a PDS prior to communication to a printer to provide a modified PDS which is more efficiently process by a printer. The PDS may be manipulated in a variety of ways, including combinations of in-line printer resource extraction, data parsing, insertion of printer control parameters, etc. In various embodiments, in-line printer resources may be extracted from the data stream and placed in a database for later access, or alternatively may be processed by software or algorithms to generate a modified resource which is reintroduced to the data stream.

### BACKGROUND OF THE INVENTION

The present invention generally relates to systems and methods for automated printing.

Large scale printing operations often utilize data file formats such as MO:DCA™ (Mixed Object Document Content Architecture), described in detail in IBM Mixed Object Document Content Architecture Reference number SC31-6802. MO:DCA page information is stored in the order that it is printed, and as such file processing can begin as soon as the information for the first page is located.

The MO:DCA file format is designed to be used with a printing system known as the “Advanced Function Presentation” (AFP) printing system developed by, and available from, IBM. This printing system utilizes an intelligent print server (Print Server Facility or PSF) within a large scale printer, which receives the AFP data stream (AFPDS), converts the AFPDS to a data stream format specific for the printer (e.g., the PSF converts the AFP data stream to an Intelligent Printer Data Stream or IPDS), and sends the IPDS to a rasterizer for printing.

During IPDS file construction, certain PSF algorithms may remove common print resources, such as fonts, from the APFDS, which print resources are then stored in a separate resource database within printer memory. A reference is placed in the IPDS file to refer to the stored resource. During printing, the printer encounters the reference and is prompted to look to the resource library stored in printer memory for the desired print resource. However, such IPDS file construction and processing requires great printer processor power and printer memory capacity, which may exceed the capacity of many printers thereby causing printer “clutching”. Instead of having the paper flow freely through the printer at a high rate of speed, a noticeable stop, pause or “clutch” is encountered. Such clutching is highly undesirable in large-scale printing operations.

The MO:DCA file format has the advantage that pages can easily be located in the data stream because the page information is stored in the order that it will be printed. The AFPDS supports objects such as Graphics Object Content Architecture (GOCA), Presentation Text Object Content Architecture (PTOCA), Image Object Content Architecture (IOCA), and Bar Code Object Content Architecture™ (BCOCA™). The AFPDS also includes many in-line print resources, such as fonts, overlays, page segments, form definitions, page definitions, etc. However, as mentioned above, the processing of such complex AFPDS by the PSF of many large scale printers can strain the processor and memory capacity of many printers.

As such, it is desirable to develop improved systems and methods for printing from AFPDS formats.

### BRIEF SUMMARY OF THE INVENTION

To address these and other needs, the present invention provides systems and methods for improving the efficiency of printing operations, particularly large-scale high speed printing operations.

Thus, in one aspect, a method for processing a print data stream (“PDS”) with in-line print resources for more efficient printing prior to sending the PDS to the printer is provided. The method generally comprises: providing a PDS including a plurality of in-line print resources to a computer comprising a processor and at least one database; and processing the PDS on the computer prior to sending the PDS to the printer, wherein the processing comprises: (i) extracting the plurality of in-line print resources and insert a print resource reference in the PDS at the location of the extracted print resource to thereby create a extracted PDS (“e-PDS”), (ii) populating the at least one database with a library including the extracted in-line print resources, and (iii) creating an instruction set including instructions to move the library to at least one print server.

In one embodiment, the method may further comprise: transmitting the e-PDS to one or more printers, wherein the one or more printers are in communication with the at least one print server(s); processing the instruction set on the computer and transmitting the library to the at least one print server(s) based on the instruction set; processing the e-PDS on the one or more printers to thereby generate printed documents based on the PDS, wherein during the processing, the one or more printers are prompted to call to the library for a desired print resource by the e-PDS to result in an end printing product as provided for in the PDS with in-line print resources.

In another aspect of the invention, a method for processing a PDS for more efficient printing prior to sending the PDS to a printer is provided. The method generally comprises: providing a PDS including a plurality of in-line print resources to a computer comprising a processor and at least one database, wherein the at least one database includes a printer service parameter list including a description of predetermined print resources; and processing the PDS including the plurality of in-line print resources on the computer prior to sending the PDS to a printer, wherein the processing comprises: (i) reading the PDS, (ii) extracting the predetermined in-line print resources from the PDS, (iii) parsing the extracted print resources to determine content and manipulating the extracted print resources if determined to be necessary by the parsing based on the printer service parameter list, and (iv) inserting the parsed print resource back to the PDS; wherein the determination and manipulation results in parsed print resources which are more efficiently processed by a printer based on predetermined printer service parameter criteria.

In one embodiment, the method further comprises, transmitting the PDS to at least one printer and processing the PDS on the printer(s) to generate printed documents.

In yet another aspect of the invention, a method for processing a PDS including text and/or bar code data comprising postal information to generate a PDS which is compliant with predetermined postal format prior to sending the PDS to a printer is provided. The method generally comprises: providing an PDS including text and/or bar code data comprising postal information to a computer comprising a processor and at least one predetermined software algorithm, wherein the at least one predetermined software algorithm is capable of generating postal text data and bar code objects in a predetermined format; and processing the PDS on the computer prior to sending the PDS to a printer, wherein the processing comprises: (i) reading the PDS, (ii) extracting the text and/or bar code data comprising postal information from the PDS, (iii) parsing the extracted text and/or bar code data to determine content and manipulating the extracted text and/or bar code data to generate a flat file if determined to be necessary by the parsing, (iv) processing the parsed text and/or bar code data through the predetermined software algorithm to generate postal text data and bar code objects in the predetermined format, and (v) inserting the parsed, formatted postal information back into the PDS at the appropriate location in the PDS; wherein the parsed, formatted postal information includes bar code information and corresponding human readable text address information in the predetermined format.

Again, in one embodiment, the method further comprises, transmitting the PDS to at least one printer and processing the PDS on the printer(s) to generate printed documents.

In yet another aspect of the invention, another method for processing a PDS for more efficient printing prior to sending the PDS to a printer is provided. This method generally comprises: providing a PDS to a computer, wherein the computer comprises at least one database, wherein the at least one database includes a predetermined printer control parameter set; and processing the PDS on the computer prior to sending the PDS to a printer, wherein the processing comprises: (i) reading the PDS, (ii) inserting predetermined printer control parameters into the PDS at predetermined locations based on the printer control parameter set, and (iii) optionally sorting the PDS based on the inserted predetermined printer control parameters. In one embodiment, the method further comprises: (iv) splitting the optionally sorted PDS into a plurality of smaller PDS (s-PDS).

Again, in one embodiment, the method further comprises, transmitting the PDS (or plurality of s-PDS) to at least one printer and processing the PDS (or plurality of s-PDS) on the printer(s) to generate printed documents.

In other aspects of the invention, various combinations of the methods described herein are provided.

These and other aspects will become apparent to one of skill in the art upon reading the disclosure.

### BRIEF DESCRIPTION OF THE DRAWINGS

FIG. 1 illustrates an exemplary system of the invention.

FIG. 2 illustrates an exemplary method of the invention, with optional step indicated in dashed lines.

FIG. 3 illustrates another exemplary method of the invention, with optional steps indicated in dashed lines.

FIG. 4 illustrates another exemplary method of the invention, with optional steps indicated in dashed lines.

FIG. 5 illustrates another exemplary method of the invention, with optional steps indicated in dashed lines.

### DETAILED DESCRIPTION OF THE INVENTION

In accordance with the present invention, the efficiency of printing systems are improved by manipulating the print data stream (PDS), e.g., an AFP data stream (AFPDS) prior to communication to the printer. As described above, the complexity of the PDS can cause clutching and other inefficiencies at the printer. As such, the present invention is directed to methods for pre-processing (e.g., manipulating) the PDS prior to communication to the printer to result in a printer data stream which is more efficiently processed by the printer. The manipulation of the PDS may include a variety of data extraction, parsing, and/or modification, etc. generally aimed at formatting the data stream for more efficient processing by a printer. As used herein, AFPDS and PDS will generally be used interchangeably, however, it should generally be understood that AFPDS is only a specific embodiment of a PDS and the invention described herein is not so limited.

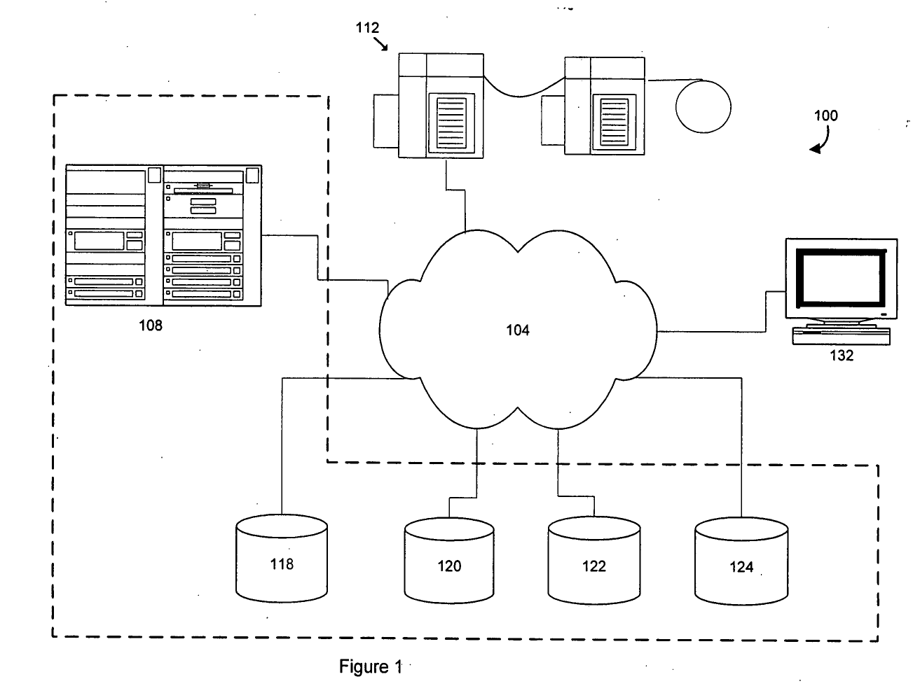

Turning now to FIG. 1, a system 100 is illustrated for improving the efficiency of printing systems in accordance with embodiments of the invention. System 100 can be implemented in a network environment (generally indicated by reference number 104). Network 104 can be any network capable of supporting communication between different computing devices. Merely by way of example, network 104 could be a local area network, an intra-network, the internet and/or any other telecommunications network, a wireless network and the like. Exemplary system 100 comprises a server computer 108 in communications with an industrial printer 112, perhaps through network 104. Server computer 108, although referred to herein as a “server,” can, in fact, be any device that includes a processor and is capable of manipulating a print data streams such as an APFDS as described in further detail in the embodiments below. Merely by way of example, server computer 108 can be a mainframe computer such as an IBM™ System/390™, a mid range system such as an IBM™ AS/400™, and/or server running a UNIX™ or UNIX-like operating system (including, for example, AIX™, Solaris™, and/or Linux™). In other embodiments, server computer 108 can be a personal computer, perhaps running one of a variety of Microsoft™ operating systems, and/or can be an Apple™ computer. In a particular embodiment, server 108 can be one of the zSeries™ mainframe computers commercially available from IBM, including the Z900™ model.

Industrial printer 112 can be any printer that is capable of processing print data streams, such as an AFPDS. In some aspects, industrial printer 112 can be a high-speed printer capable of processing an AFPDS to generate a printed document quickly, but one of skill will recognize that any AFP capable printer may be used. Although the invention need not be limited to such printers, merely by way of example, in some cases industrial printer 112 can be a model 3090 continuous form printer or Infoprint 3000, 4000, or 4100 printers commercially available from IBM™. Generally, printer 112 will include processor(s), database(s), print server(s) (e.g., intelligent print servers such as the Print Server Facility or PSF), rasterizer(s), etc. Printer 112 may communicate with server 108 via any methodology known in the art. Further, files and data can be transmitted between printer 112 and server 108 via any known methodology, such as NDS (Novell Netware) and/or Cyberfusion (Proginet Corporation), but FTP or other file transfer methodologies may also be used, as known in the art.

In particular embodiments, system 100 can, in some embodiments, comprise a plurality of processors. Each of the plurality of processors can perform one or more of the processing tasks discussed herein. Further, each of the plurality of processors can be in communication with one or more computer readable media, including, for instance disk drives, memory devices and the like which can include instructions executable by the processors to perform the functions discussed herein.

In accordance with various embodiments of the invention, system 100 can include one or more databases 118, 120, 122, 124, etc. which can be used to store a variety of information related to the inventive methods discussed herein. Those skilled in the art will appreciate that although, for purposes of clarity, databases 118, 120, 122, 124 are illustrated separately on FIG. 1, other embodiments of the invention might incorporate all of the stored data within a single database and/or organize data structures differently than as illustrated herein. Further, although illustrated as separate physical elements in FIG. 1, databases 118, 120, 122, 124 may alternatively be housed within server computer 108 (as indicated by the dashed line in FIG. 1). As discussed herein, when reference is made to server computer 108 including or comprising a database, it is understood that the database may be within the computer housing itself, or may be a separate structure in communication with server computer 108.

In embodiments utilizing the information bus model discussed herein, the information discussed with respect to databases 118, 120, 122, 124 may be pushed and/or pulled from the bus, allowing for data acquisition from a wide variety of sources. The term “database,” therefore, should be interpreted to mean a collection of information rather than read as a limitation to a particular physical or logical structure or organization. Databases 118, 120, 122, 124 can be in communication with server computer 108 either through network 104 (as illustrated on FIG. 1), through direct communication (e.g., SCSI connection, etc.) and/or through any other method known in the art, so long as server computer 108 can access the information stored within databases 118, 120, 122, 124.

As will be discussed in more detail below, databases 118, 120, 122, 124 may comprise various combinations of data, parameters, resources, instructions, etc. for use during manipulation of the print data stream and/or for communication to printer 112 for use during printing. By way of non-limiting example, databases 118, 120, 122, 124 may comprise in-line print resources, printer control parameter sets, printer service parameter lists, instruction sets, etc. Those skilled in the art will recognize that there are a variety of ways of storing composite information in a database, any of which can be implemented in accordance with various embodiments of the invention. For instance, database 118, 120, 122, 124 can be incorporated within a software package (e.g., Coding Accuracy Support System or CASS™ certified software, etc.), and server 108 can be configured to interface with such software package in order to assess and generate CASS™ compliant postal information (discussed in more detail below).

Those skilled in the art will recognize that there are a variety of ways in which server computer 108 might interface with database 118, 120, 122, 124. In a particular aspect server 108 can access information in database 118, 120, 122, 124 on a periodic basis or on demand. Various standardized (e.g., OOBC, SQL, XML, etc.) and/or proprietary data access methodologies known in the art may be used to access databases 118, 120, 122, 124. Further, data may either be pushed from a database or “pulled” by server 108.

Alternatively, databases 118, 120, 122, 124 and/or server 108 can engage in a practice known in the art as “push-pull” data warehousing, whereby information can be shared with and/or pulled from another source. Such data warehousing can be done within an enterprise or between multiple enterprises and can be performed using any of a variety of methods known to those skilled in the art including, merely by way of example, XML data transfers. In these and other ways, embodiments of the present invention, as discussed above, can interface with an information bus operation on an intra-company or inter-company basis, and can both pull information from that bus and push information to the information bus. Thus, systems in accordance with embodiments of the invention can easily integrate with other data management systems in the provider's network, for example by utilizing the information bus methodology described briefly herein and known to those skilled in the art.

In accordance with some embodiments, system 100 can include a computing device 132 that can be in communication with server 108 and/or printer 112 and that can be used, inter alia, to provide configuration and operational instructions to either server 108 or printer 112. Computing device 132 can be any device known in the art that is capable of communicating with server 108 and/or printer 112, including, for example, a personal computer (perhaps running a Microsoft™ and/or Apple™ operating system), a personal digital assistant, a mini-computer, a workstation, a cell phone, and/or the like. Communication with server 108 and/or printer 112 can be through network 104 as illustrated in FIG. 1, or alternatively, can be through some other means of communication including wireless communication, direct connection and the like. Device 132 can be used to add, delete and/or modify any of the information contained within databases 118, 120, 122, 124. For instance, device 132 can be used to add, delete, or modify font resource parameters stored in one or more databases 118, 120, 122, 124. However, in many circumstances, databases 118, 120, 122, 124 will be populated automatically, e.g., via an information bus, through the activities of other software applications (e.g., CASS™ certified software and the like), or server extraction and parsing services, as described below.

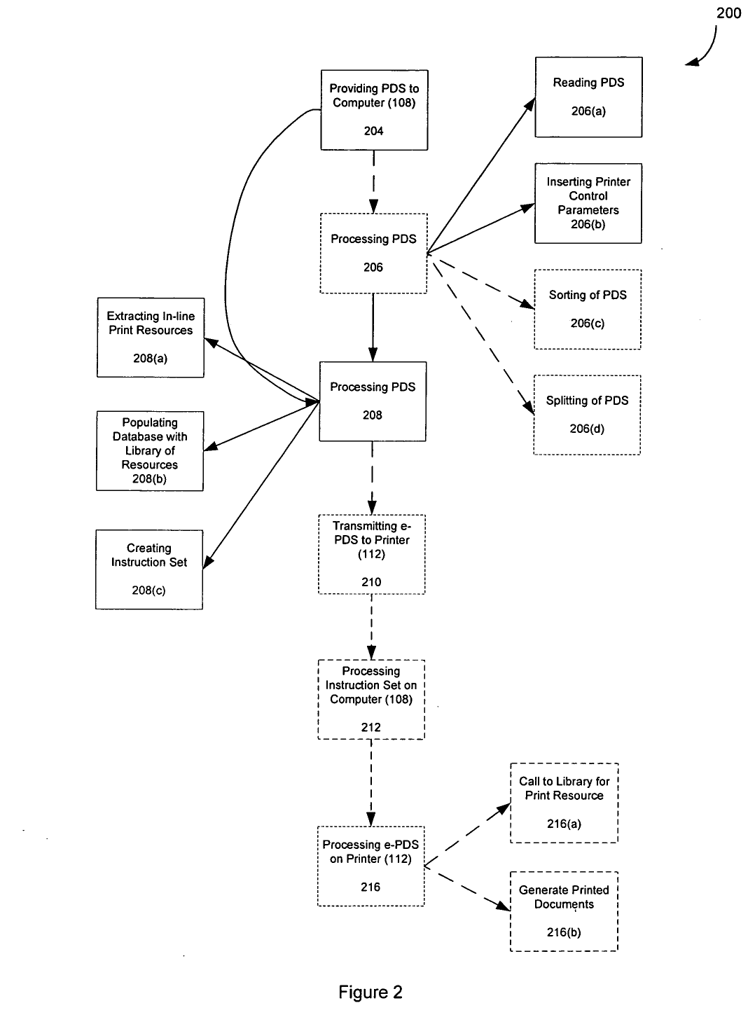

In another aspect of the invention, methods for improving the efficiency of printing of print data streams are provided. As mentioned above, the methods generally involve manipulating a PDS prior to communication to a printer to provide a modified PDS which is more efficiently processed by a printer. With reference to system 100 described above, a print data stream, such as an AFPDS is generally communicated to server 108, and server 108 manipulates the PDS to generate the modified PDS, which is then communicated to printer 112 for printing. The PDS may be manipulated in a variety of ways, including combinations of in-line printer resource extraction, data parsing, insertion of printer control parameters, etc. In various embodiments, in-line printer resources may be extracted from the data stream and placed in a database for later access, or alternatively may be processed by software or algorithms to generate a modified resource which is reintroduced to the data stream. Certain embodiments will be discussed in more detail below with reference to FIGS. 2, 3, 4, and 5.

Turning now to FIG. 2, a method 200 is illustrated is for improving the efficiency of printing from a print data stream such as an AFPDS. Although for ease of description, method 200 will be described by reference to system 100, those skilled in the art will understand that methods in accordance with various embodiments of the invention are not limited to any particular hardware or physical structure(s). In accordance with exemplary method 200, a method for processing a print data stream (“PDS”) with in-line print resources for more efficient printing is provided. Generally, the method involves at block 204, providing a PDS including a plurality of in-line print resources to a computer (108) comprising a processor and at least one database (e.g., 118). At block 208, the PDS is processed on computer (108) prior to communication to printer (112). In one embodiment, processing block 208 includes at step 208(a), extracting the in-line print resources from the PDS and inserting a print resource reference in the PDS at the location of the extracted print resource to thereby create an extracted PDS (“e-PDS”). Following step 208(a) the database (e.g., 118) is populated with a library including the extracted in-line print resources at step 208(b), and an instruction set including instructions to move the library to at least one external print server is created at step 208(c).

In one embodiment, method 200 may continue to block 210 where the extracted PDS is transmitted to one or more printers (112), wherein the one or more printers (112) are in communication with the at least one print servers. As known in the art, printers (112) may include the print servers within their physical housing, or may be in communication with the print servers through, e.g., a network. In either event, as used herein, reference to a printer in communication with a print server is intended to refer to any known configuration, e.g., wherein the print server is integral to the printer or external to the printer. At block 212, the instruction set may be processed on computer (108) and the library of in-line print resources may be transmitted to the at least one print servers at block 214 based on the instruction set. Continuing on, at block 216, the extracted PDS may be processed on the one or more printers (112) to thereby generate printed documents based on the PDS, 216(b). During processing block 216, the printers (112) are prompted to call to the library for a desired print resource by the e-PDS at step 216(a) to result in an end printing product as provided for in the PDS with in-line print resources at step 216(b).

The in-line print resources which are extracted and written to the library in block 208 may be any know print resources that are included in print data streams such as AFP data streams. As discussed above, such in-line print resources include page elements and architecture selected such as, but not limited to font character sets, coded fonts, code pages, text, bar codes, overlays, images, graphics, and combinations thereof.

In yet another embodiment, method 200 may optionally include block 206, wherein the PDS is processed on computer (108). Generally, in connection with block 206, computer (108) will include at least a second database (e.g., 120), wherein the second database (e.g., 120) includes a predetermined printer control parameter set. In step 206(a), computer (108) reads the PDS, and in step 206(b) predetermined printer control parameters based on the printer control parameter set are inserted into the PDS. Moving on, in optional step 206(c), the PDS may be sorted based on the inserted predetermined printer control parameters. In one embodiment, the PDS may be sorted in a predetermined order, such as ascending page number order, type of document, origin of document, destination of document (foreign mail, domestic mail, invalid address, etc.), and combinations thereof.

The predetermined printer control parameter set may include any known printer control parameters suitable for the printer of use. By way of example, certain printer control parameters include barcodes (e.g., C128 inserted barcodes), human readable counterpart to barcodes, document sequence numbers, document control lines, and combinations thereof.

In yet another embodiment of method 200, block 206 may further include step 206(d) wherein the optionally sorted PDS is split into a plurality of smaller PDS (s-PDS). The smaller PDS may then be passed to block 208 for further processing. In one embodiment, the PDS may be split into the smaller PDS based on a predetermined number of documents within each individual s-PDS, such that each s-PDS consists of a predetermined maximum number of documents to be printed.

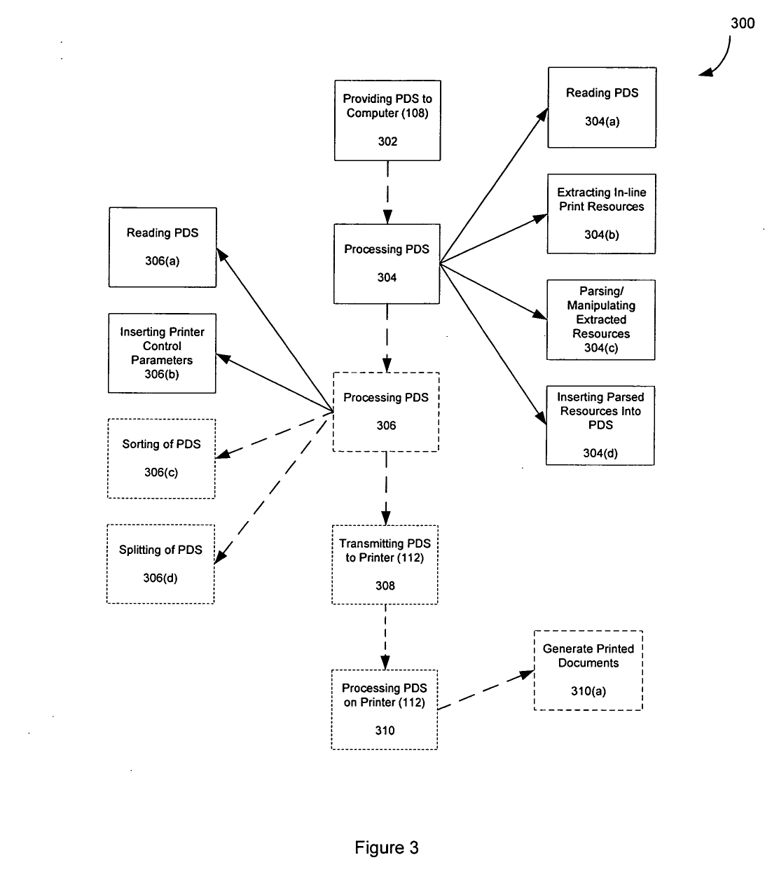

Turning now to FIG. 3, a method 300 for improving the efficiency of printing from a print data stream such as an AFPDS is illustrated. Again, although for ease of description, method 300 will be described by reference to system 100, those skilled in the art will understand that methods in accordance with various embodiments of the invention are not limited to any particular hardware or physical structure(s). In accordance with exemplary method 300, a method for processing a print data stream (“PDS”) is provided, wherein method 300 generally includes at block 302, providing a PDS including a plurality of in-line print resources to a computer (108) comprising a processor and at least one database (e.g., 118). In the context of method 300, the at least one database (e.g., 118) will comprise a printer service parameter list including a description of predetermined print resources. Moving on, the PDS is processed at block 304 prior to communication to printer (112). Block 304 includes reading the PDS at step 304(a), and extracting the predetermined in-line print resources from the PDS at step 304(b). The extracted print resources are then parsed to determine content and manipulated if determined to be necessary by the parsing at step 304(c) based on the printer service parameter list. The parsed print resource is then inserted back into the PDS at step 304(d). The parsing of step 304(c) results in parsed print resources which are more efficiently processed by a printer of interest based on the predetermined printer service parameter criteria, wherein the printer service parameter criteria are specific to the printer of interest.

Any in-line print resources may be processed in this manner. By way of example, font resources may be extracted and parsed. The font resources may be extracted, compared to a printer service parameter list to determine if the font resources are supported by the printer of interest, and if the font resources are supported, the font resources can simply be reinserted into the PDS. However, if the font resources are not support by the printer of interest, the computer may modify the font resources based on the predetermined printer service parameter criteria to result in font resources which are supported by the printer of interest. The modified font resources may then be reinserted back into the PDS for further processing and/or printing.

In one embodiment, method 300 may continue to block 308 where the PDS is transmitted to one or more printers (112). At block 310, the PDS may be processed on the one or more printers (112) to thereby generate printed documents based on the PDS, 310(a).

In yet another embodiment, method 300 may optionally include block 306, wherein the PDS is processed on computer (108). Generally, in connection with block 306, computer (108) will include at least a second database (e.g., 120), wherein the second database (e.g., 120) includes a predetermined printer control parameter set. In step 306(a), computer (108) reads the PDS, and in step 306(b) predetermined printer control parameters based on the printer control parameter set are inserted into the PDS. Moving on, in optional step 306(c), the PDS may be sorted based on the inserted predetermined printer control parameters. In one embodiment, the PDS may be sorted in a predetermined order, such as ascending page number order, type of document, origin of document, destination of document (foreign mail, domestic mail, invalid address, etc.), and combinations thereof.

Again, the predetermined printer control parameter set may include any known printer control parameters suitable for the printer of use. By way of example, certain printer control parameters include barcodes (e.g., C128 inserted barcodes), human readable counterpart to barcodes, document sequence numbers, document control lines, and combinations thereof.

In yet another embodiment of method 300, block 306 may further include step 306(d) wherein the optionally sorted PDS is split into a plurality of smaller PDS (s-PDS). The smaller PDS may then be passed to block 308 for further processing. In one embodiment, the PDS may be split into the smaller PDS based on a predetermined number of documents within each individual s-PDS, such that each s-PDS consists of a predetermined maximum number of documents to be printed.

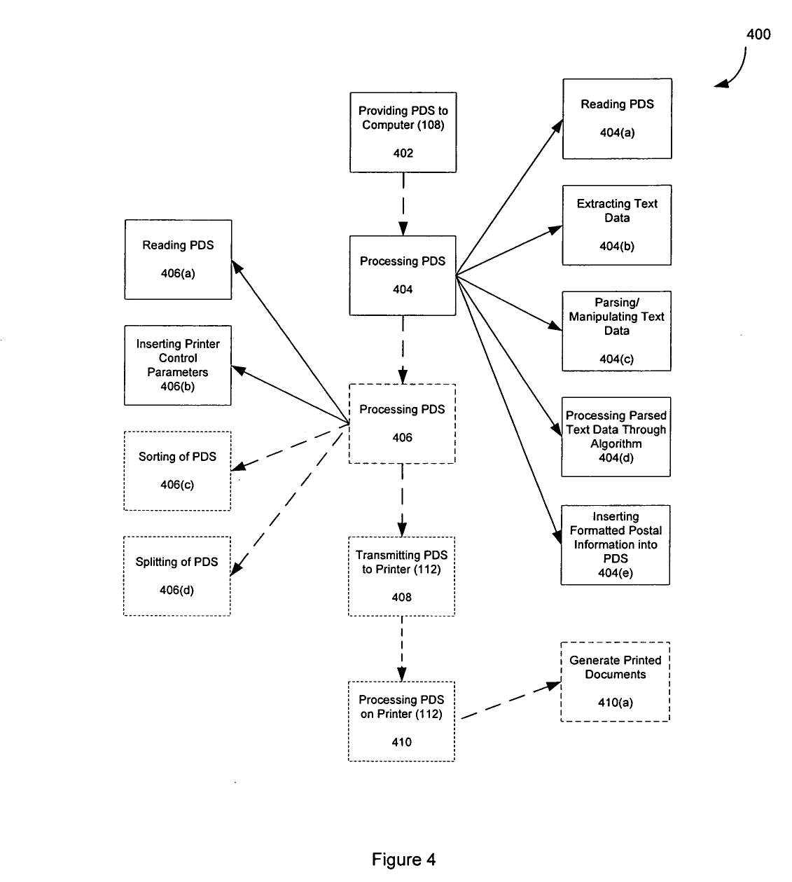

Turning now to FIG. 4, a method 400 for improving the efficiency of printing from an print data stream including text and/or bar code data comprising postal information, such as an AFPDS is illustrated. Again, although for ease of description, method 400 will be described by reference to system 100, those skilled in the art will understand that methods in accordance with various embodiments of the invention are not limited to any particular hardware or physical structure(s). In accordance with exemplary method 400, a method for processing a print data stream (“PDS”) is provided, wherein method 400 generally includes at block 402, providing a PDS including text and/or bar code data comprising postal information to a computer (108) comprising a processor and at least one predetermined software algorithm. The predetermined software algorithm may be any software algorithm known in the art that is capable of generating postal text data and bar code objects in a predetermined format, such as, e.g., Coding Accuracy Support System (CASS™) certified software. Suitable software titles may be found at http://ribs.usps.gov/files/vendors/cassn01.txt. Moving on, the PDS is processed on computer (108) at block 404 prior to communication to printer (112). Block 404 includes reading the PDS at step 404(a) and extracting the text and/or bar code data including the postal information at step 404(b). The extracted text and/or bar code data is then parsed to determine content and manipulated to generate a flat file input if determined to be necessary by the parsing at step 404(c) (e.g., if determined to be non-compliant with CASS™ requirements). The parsed text and/or bar code data is then processed through the predetermined software algorithm to generate postal text data and bar code objects in the predetermined format at step 404(d) and the reformatted postal information is inserted into the PDS at the appropriate location at step 404(e). In one embodiment, the reformatted postal information includes bar code information and corresponding human readable text address information in a predetermined format, such as a CASS™ certified format.

In one embodiment, method 400 may continue to block 408 where the PDS is transmitted to one or more printers (112). At block 410, the PDS may be processed on the one or more printers (112) to thereby generate printed documents based on the PDS, 410(a).

In yet another embodiment, method 400 may optionally include block 406, wherein the PDS is processed on computer (108). Generally, in connection with block 406, computer (108) will include at least one database (e.g., 118), wherein the at least one database (e.g., 118) includes a predetermined printer control parameter set. In step 406(a), computer (108) reads the PDS, and in step 406(b) predetermined printer control parameters based on the printer control parameter set are inserted into the PDS. Moving on, in optional step 406(c), the PDS may be sorted based on the inserted predetermined printer control parameters. In one embodiment, the PDS may be sorted in a predetermined order, such as ascending page number order, type of document, origin of document, destination of document (foreign mail, domestic mail, invalid address, etc.), and combinations thereof.

Again, the predetermined printer control parameter set may include any known printer control parameters suitable for the printer of use. By way of example, certain printer control parameters include barcodes (e.g., C128 inserted barcodes), human readable counterpart to barcodes, document sequence numbers, document control lines, and combinations thereof.

In yet another embodiment of method 400, block 406 may further include step 406(d) wherein the optionally sorted PDS is split into a plurality of smaller PDS (s-PDS). The smaller PDS may then be passed to block 408 for further processing. In one embodiment, the PDS may be split into the smaller PDS based on a predetermined number of documents within each individual s-PDS, such that each s-PDS consists of a predetermined maximum number of documents to be printed.

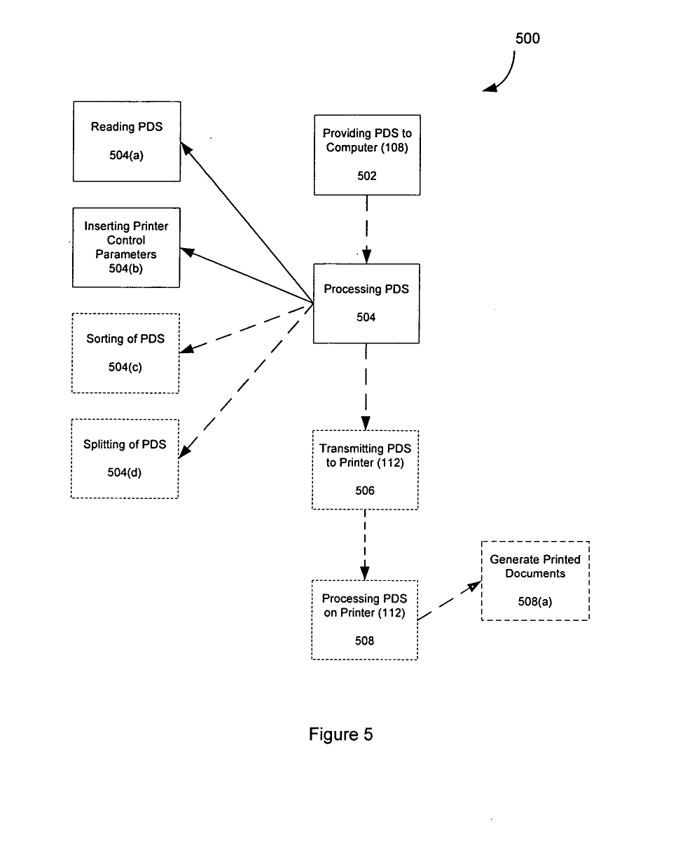

Turning now to FIG. 5, a method 500 for improving the efficiency of printing from a print data stream, such as an AFPDS is illustrated. Again, although for ease of description, method 500 will be described by reference to system 100, those skilled in the art will understand that methods in accordance with various embodiments of the invention are not limited to any particular hardware or physical structure(s). In accordance with exemplary method 500, a method for processing a print data stream (“PDS”) is provided, wherein method 500 generally includes at block 502, providing a PDS, wherein the PDS is processed on computer (108). Generally, in connection with block 502, computer (108) will include at least one database (e.g., 118), wherein the at least one database (e.g., 118) includes a predetermined printer control parameter set. The PDS is processed in block 504 prior to communication to printer (112). In step 504(a), computer (108) reads the PDS, and in step 504(b), predetermined printer control parameters based on the printer control parameter set are inserted into the PDS. Moving on, in optional step 504(c), the PDS may be sorted based on the inserted predetermined printer control parameters. In one embodiment, the PDS may be sorted in a predetermined order, such as ascending page number order, type of document, origin of document, destination of document (foreign mail, domestic mail, invalid address, etc.), and combinations thereof.

Again, the predetermined printer control parameter set may include any known printer control parameters suitable for the printer of use. By way of example, certain printer control parameters include barcodes (e.g., C128 inserted barcodes), human readable counterpart to barcodes, document sequence numbers, document control lines, and combinations thereof.

In yet another embodiment of method 500, block 504 may further include step 504(d) wherein the optionally sorted PDS is split into a plurality of smaller PDS (s-PDS). The smaller PDS may then be passed to block 506 for further processing. In one embodiment, the PDS may be split into the smaller PDS based on a predetermined number of documents within each individual s-PDS, such that each s-PDS consists of a predetermined maximum number of documents to be printed.

In one embodiment, method 500 may continue to block 506 where the PDS is transmitted to one or more printers (112). At block 508, the PDS may be processed on the one or more printers (112) to thereby generate printed documents based on the PDS, 508(a).

In another aspect of the invention, various combinations of the methods illustrated in FIGS. 2, 3, 4, and 5 are envisioned. For instance, a PDS may be processed in accordance with the method illustrated in FIG. 3 and/or 4, and then processed in accordance with FIG. 2.

In this way, embodiments in the invention provide novel systems and methods for improving the efficiency of printing operations. The description above identifies certain exemplary embodiments for implementing the invention, but those skilled in the art will recognize that many modifications and variations are possible within the scope of the invention. Therefore, the invention is defined only by the claims set forth below.

What is claimed is:

1. A method for processing a print data stream (“PDS”) with in-line print resources for more efficient printing, said method comprising:
providing a PDS including a plurality of in-line print resources to a computer comprising a processor and at least one database; and
processing said PDS on said computer prior to communication to a printer, wherein said processing comprises: (i) extract said plurality of in-line print resources and insert a print resource reference in the PDS at the location of the extracted print resource to thereby create a extracted PDS (“e-PDS”), (ii) populate said at least one database with a library including said extracted in-line print resources, and (iii) create an instruction set including instructions to move said library to at least one print server.

2. The method of claim 1, further comprising:
transmitting said e-PDS to one or more printers, wherein said one or more printers are in communication with said at least one print servers;
processing said instruction set on said computer and transmitting said library to said at least one print servers based on said instruction set;
processing said e-PDS on said one or more printers to thereby generate printed documents based on said PDS, wherein during said processing, said one or more printers are prompted to call to said library for a desired print resource by the e-PDS to result in an end printing product as provided for in said PDS with in-line print resources.

3. The method of claim 1, wherein said plurality of in-line print resources include page elements and architecture selected from the group consisting of: font character sets, coded fonts, code pages, text, bar codes, overlays, images, graphics, and combinations thereof.

4. The method of claim 1, wherein said computer comprises at least a second database, wherein said second database includes a predetermined printer control parameter set; and
wherein said method comprises processing said PDS on said computer prior to extraction of in-line print resources, said processing comprising: (i) reading the PDS, (ii) inserting predetermined printer control parameters into said PDS at predetermined locations based on said printer control parameter set, and (iii) optionally sorting said PDS based on said inserted predetermined printer control parameters.

5. The method of claim 4, wherein said predetermined printer control parameter set includes printer control selected from the group consisting of: barcode, human readable counterpart to barcode, document sequence number, document control line, and combinations thereof.

6. The method of claim 4, wherein the PDS is sorted in a predetermined order.

7. The method of claim 6, wherein said predetermined order is selected from the group consisting of: ascending page number order, type of document, origin of document, destination of document, and combinations thereof.

8. The method of claim 4, further comprising (iv) splitting the optionally sorted PDS into a plurality of smaller PDS (s-PDS), wherein each s-PDS is then individually processed through extraction of the in-line print resources to form a plurality of e-PDS, a plurality of databases of libraries of print resources, and a plurality of instruction sets.

9. The method of claim 8, wherein the PDS is split into said plurality of smaller PDS based on a predetermined number of documents within each individual s-PDS, such that each s-PDS consists of a predetermined maximum number of documents to be printed.

10. The method of claim 8, wherein said method further comprises
transmitting each of said plurality of e-PDS to a plurality of separate printers, wherein each of said plurality of separate printers are in communication with said at least one print server;
processing said plurality of instruction sets on said computer and transmitting said libraries to said at least one print servers based on said plurality of instruction sets;
processing said plurality of e-PDS on said plurality of separate printers to thereby print said plurality of e-PDS, wherein during said processing, said plurality of separate printers are prompted to call to said libraries for a desired print resource by each respective e-PDS to result in an end printing product as provided for in said PDS with in-line print resources.

11. The method of claim 4, wherein the at least one database and the at least a second database are located on a single physical media or on separate physical media.

12. A method for processing a PDS for more efficient printing, said method comprising:
providing a PDS including a plurality of in-line print resources to a computer comprising a processor and at least one database, wherein said at least one database includes a printer service parameter list including a description of predetermined print resources;
processing said PDS including said plurality of in-line print resources on said computer prior to communication to a printer, wherein said processing comprises: (i) reading said PDS, (ii) extracting said predetermined in-line print resources from said PDS, (iii) parsing said extracted print resources to determine content and manipulating said extracted print resources if determined to be necessary by said parsing based on said printer service parameter list, and (iv) inserting said parsed print resource back to said PDS;
wherein said determination and manipulation results in parsed print resources which are more efficiently processed by a printer based on predetermined printer service parameter criteria.

13. The method of claim 12, wherein said computer comprises at least a second database, wherein said second database includes a predetermined printer control parameter set; and
wherein said method further comprises a second processing of said PDS on said computer following said extraction, parsing, and, inserting processing; said second processing comprising: (i) reading the PDS, (ii) inserting predetermined printer control parameters into said PDS at predetermined locations based on said printer control parameter set, and (iii) optionally sorting said PDS based on said inserted predetermined printer control parameters.

14. The method of claim 13, wherein said predetermined printer control parameter set includes printer control selected from the group consisting of: barcode, human readable counterpart to barcode, document sequence number, document control line, and combinations thereof.

15. The method of claim 13, wherein the PDS is sorted in a predetermined order.

16. The method of claim 15, wherein said predetermined order is selected from the group consisting of: ascending page number order, type of document, origin of document, destination of document, and combinations thereof.

17. The method of claim 13, wherein said second processing further comprises: (iv) splitting said optionally sorted PDS into a plurality of smaller PDS (s-PDS).

18. The method of claim 17, wherein the PDS is split into said plurality of smaller PDS based on a predetermined number of documents within each individual s-PDS, such that each s-PDS consists of a predetermined maximum number of documents to be printed.

19. The method of claim 17, wherein said method further comprises
transmitting each of said plurality of s-PDS to a plurality of separate printers and processing each of said s-PDS on each respective printer to generate printed documents, wherein said predetermined printer service parameter list and said predetermined printer control parameter set are determined based on the specific printer of interest.

20. The method of claim 13, wherein the at least one database and the at least a second database are located on a single physical media or on separate physical media.

21. A method for processing a PDS including data comprising postal information to generate a PDS which is compliant with predetermined postal format, said method comprising:
providing an PDS including data comprising postal information to a computer comprising a processor and at least one predetermined software algorithm, wherein said at least one predetermined software algorithm is capable of generating postal text data and bar code objects in a predetermined format;
processing said PDS on said computer prior to communication to a printer, wherein said processing comprises: (i) reading said PDS, (ii) extracting said data comprising postal information from said PDS, (iii) parsing said extracted data to determine content and manipulating said extracted data to generate a flat file if determined to be necessary by said parsing, (iv) processing said parsed data through said predetermined software algorithm to generate postal text data and bar code objects in said predetermined format, and (v) inserting said parsed, formatted postal information back into the PDS at the appropriate location in the PDS;
wherein the parsed, formatted postal information includes bar code information and corresponding human readable text address information in said predetermined format.

22. The method of claim 21, wherein said computer comprises at least a second database, wherein said second database includes a predetermined printer control parameter set; and
wherein said method further comprises a second processing of said PDS on said computer following said extraction, parsing, formatting and, inserting processing; said second processing comprising: (i) reading the PDS, (ii) inserting predetermined printer control parameters into said PDS at predetermined locations based on said printer control parameter set, and (iii) optionally sorting said PDS based on said inserted predetermined printer control parameters.

23. The method of claim 22, wherein said predetermined printer control parameter set includes printer control selected from the group consisting of: barcode, human readable counterpart to barcode, document sequence number, document control line, and combinations thereof.

24. The method of claim 23, wherein the PDS is sorted in a predetermined order.

25. The method of claim 24, wherein said predetermined order is selected from the group consisting of: ascending page number order, type of document, origin of document, destination of document, and combinations thereof.

26. The method of claim 22, wherein said second processing further comprises: (iv) splitting said optionally sorted PDS into a plurality of smaller PDS (s-PDS).

27. The method of claim 26, wherein the PDS is split into said plurality of smaller PDS based on a predetermined number of documents within each individual s-PDS, such that each s-PDS consists of a predetermined maximum number of documents to be printed.

28. The method of claim 26, wherein said method further comprises
transmitting each of said plurality of s-PDS to a plurality of separate printers and processing each of said s-PDS on each respective printer to generate printed documents, wherein said predetermined printer service parameter list and said predetermined printer control parameter set are determined based on the specific printer of interest.

29. The method of claim 22, wherein the at least one database and the at least a second database are located on a single physical media or on separate physical media.

30. A method for processing a PDS for more efficient printing, said method comprising,
providing a PDS to a computer, wherein said computer comprises at least one database, wherein said at least one database includes a predetermined printer control parameter set; and
processing said PDS on said computer prior to communication to a printer, wherein said processing comprises: (i) reading the PDS, (ii) inserting predetermined printer control parameters into said PDS at predetermined locations based on said printer control parameter set, and (iii) optionally sorting said PDS based on said inserted predetermined printer control parameters.

31. The method of claim 30, wherein said predetermined printer control parameter set includes printer control selected from the group consisting of: barcode, human readable counterpart to barcode, document sequence number, document control line, and combinations thereof.

32. The method of claim 30, wherein the PDS is sorted in a predetermined order.

33. The method of claim 32, wherein said predetermined order is selected from the group consisting of: ascending page number order, type of document, origin of document, destination of document, and combinations thereof.

34. The method of claim 30, wherein said processing further comprises: (iv) splitting said optionally sorted PDS into a plurality of smaller PDS (s-PDS).

35. The method of claim 34, wherein the PDS is split into said plurality of smaller PDS based on a predetermined number of documents within each individual s-PDS, such that each s-PDS consists of a predetermined maximum number of documents to be printed.

36. The method of claim 34 wherein said method further comprises
transmitting each of said plurality of s-PDS to a plurality of separate printers and processing each of said s-PDS on each respective printer to generate printed documents, wherein said predetermined printer control parameter set are determined based on the specific printer of interest.
